(19) United States
(12) Patent Application Publication
(10) Pub. No.: US 2017/0258045 A1
(43) Pub. Date: Sep. 14, 2017

(54) CATNIP DISPENSING DEVICE

(71) Applicant: Multipet International, Moonachie, NJ (US)

(72) Inventors: Richard Koliner, Moonachie, NJ (US); Mark Hirschberg, Moonachie, NJ (US)

(21) Appl. No.: 15/457,419

(22) Filed: Mar. 13, 2017

Related U.S. Application Data
(60) Provisional application No. 62/307,010, filed on Mar. 11, 2016.

(51) Int. Cl. A01K 15/02

(52) U.S. Cl. CPC A01K 15/025

(57) ABSTRACT

A dispenser for dispensing a material stored in a container, including a first hemisphere, and a second hemisphere having a puncture arm and at least one aperture, wherein the first and second hemispheres are capable of being mechanically coupled together and when mechanically coupled accommodate the container, and when mechanically coupled the puncture arm punctures the container allowing at least a portion of the material in the container to exit the container and the dispenser via the aperture.

### CROSS-REFERENCE TO RELATED APPLICATIONS

This application claims priority to U.S. Provisional Application Ser. No. 62/307,010 filed on Mar. 11, 2016, the entire contents of which are hereby incorporated by reference.

### BACKGROUND OF THE INVENTION

The present invention relates to a catnip dispensing device. Other dispensing devices are as follows: U.S. Pat. No. 7,246,574 Renforth; U.S. Pat. No. 5,191,856 Gordon; U.S. Pat. No. 7,150,245 Lamstein; U.S. Pat. No. 2,650,740 Hammerstein; U.S. Pat. No. 7,104,222 Tsengas; U.S. Pat. No. 2,086,631 Munro; U.S. Pat. No. 6,899,059 Crane et al.; U.S. Pat. No. 1,534,964 Kahnweiler; U.S. Pat. No. 6,237,538 Tsengas; U.S. Pat. No. 1,022,112 Smith; U.S. Pat. No. 5,865,147 Rubin; U.S. Pat. No. 1,006,182 Cousin; U.S. Pat. No. 5,819,690 Brown; U.S. Pat. No. 5,813,366 Mauldin, Jr.; U.S. Pat. Publ. No. 2012/0085294 A1 Christianson.

### SUMMARY OF THE INVENTION

A dispenser for dispensing a material stored in a container, including a first hemisphere, and a second hemisphere having a puncture arm and at least one aperture, wherein the first and second hemispheres are capable of being mechanically coupled together and when mechanically coupled accommodate the container, and when mechanically coupled the puncture arm punctures the container allowing at least a portion of the material in the container to exit the container and the dispenser via the aperture.

### BRIEF DESCRIPTION OF THE DRAWINGS

FIGS. 1A-C; 2A-C; 3A-C; 4A-C; 5A-C; 6A-C; 7A-D are views of a device in accordance with an aspect of the present invention.

FIGS. 8A-C; 9A-C; 10A-C; 11A-C; 12A-C; 13A-C; 14A-C; 15A-C; 16A-C; 17A-C; 18A-C; 19A-C; 20A-D are views of a device in accordance with another aspect of the present invention.

FIGS. 21A-C; 22A-C; 23A-C; 24A-C; 25A-C; 26A-C; 27A-C; 28A-C; 29A-C; 30A-C; 31A-D are views of a device in accordance with another aspect of the present invention.

FIGS. 32-33 are depictions of a device in accordance with another aspect of the present invention.

FIG. 34 is a cross sectional view of a device in accordance with another aspect of the present invention.

FIGS. 35-41 are external views of a device in accordance with another aspect of the present invention.

FIGS. 42-48 are external views of a device in accordance with another aspect of the present invention.

### DETAILED DESCRIPTION OF ASPECTS OF THE INVENTION

The subject matter that is regarded as the invention is particularly pointed out and distinctly claimed in the concluding part of the specification. The invention of the present disclosure relates to a dispenser for dispending catnip, although it will be understood that other material may be dispensed.

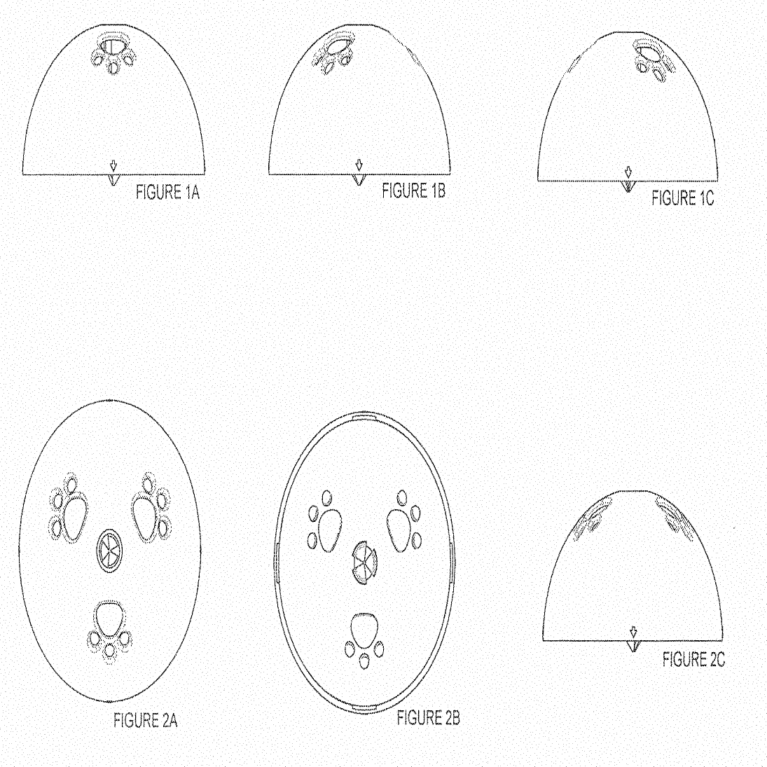

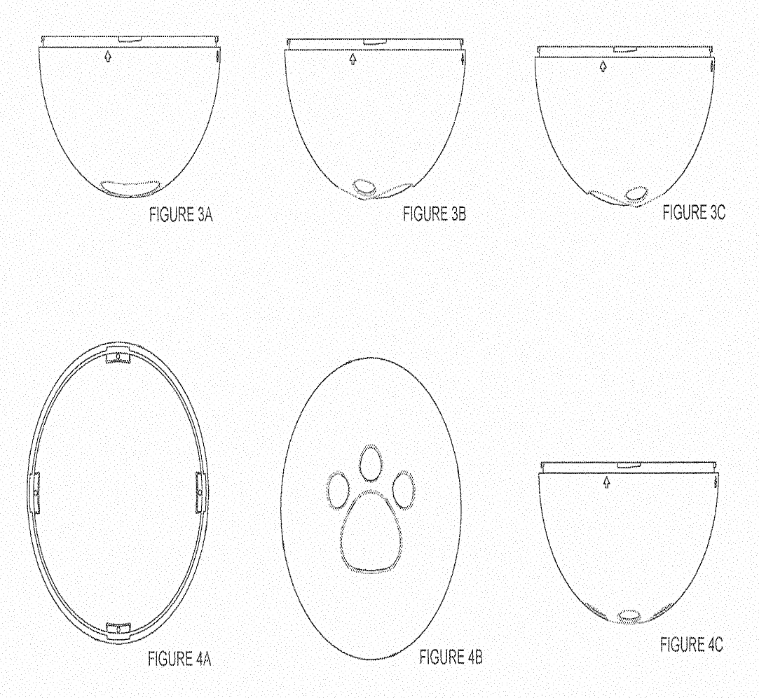

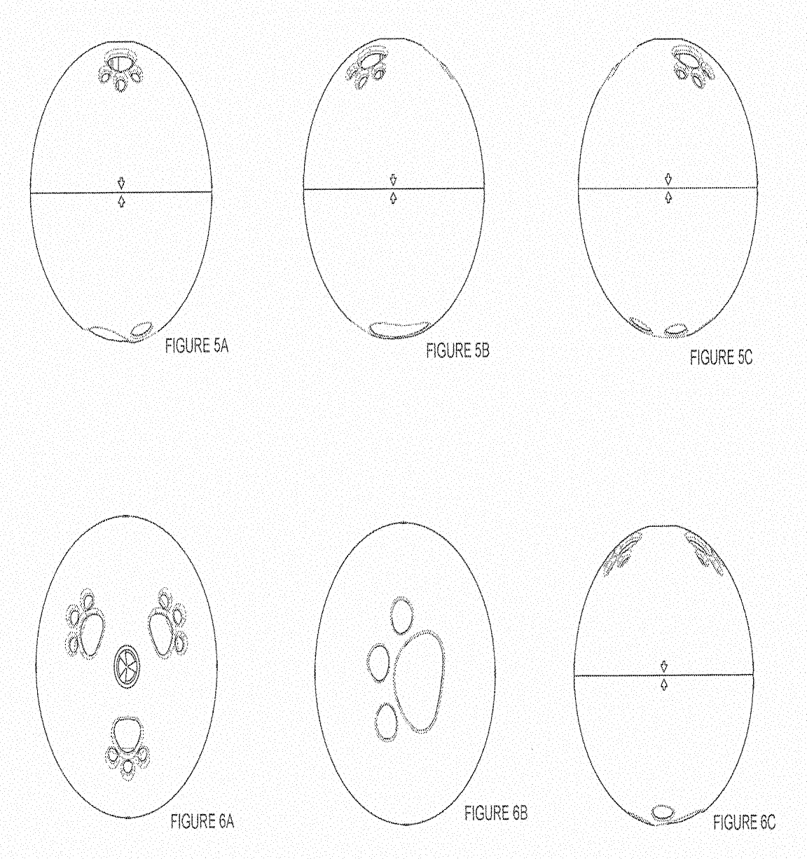

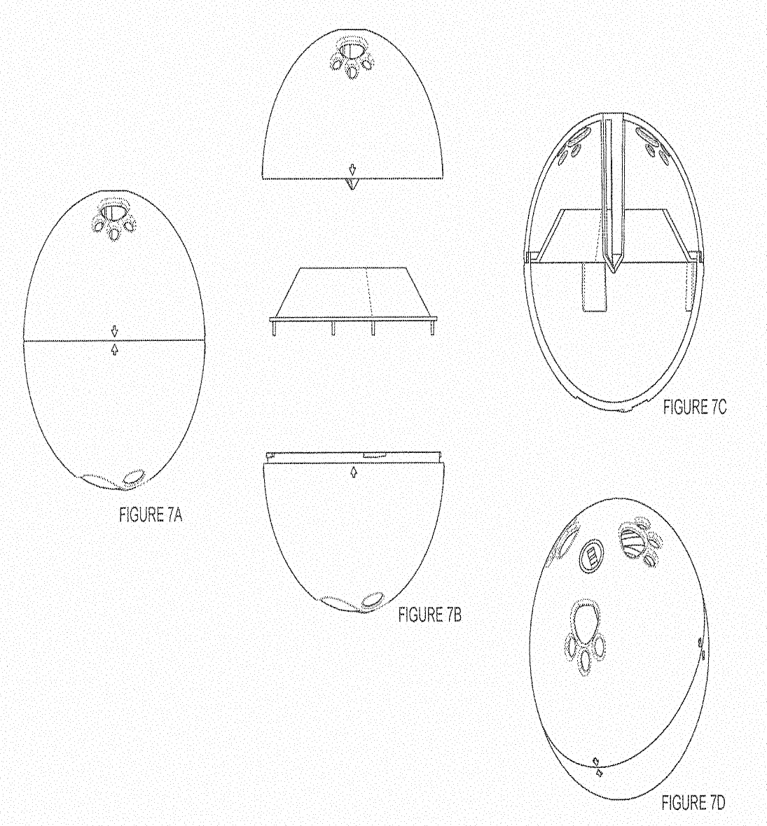

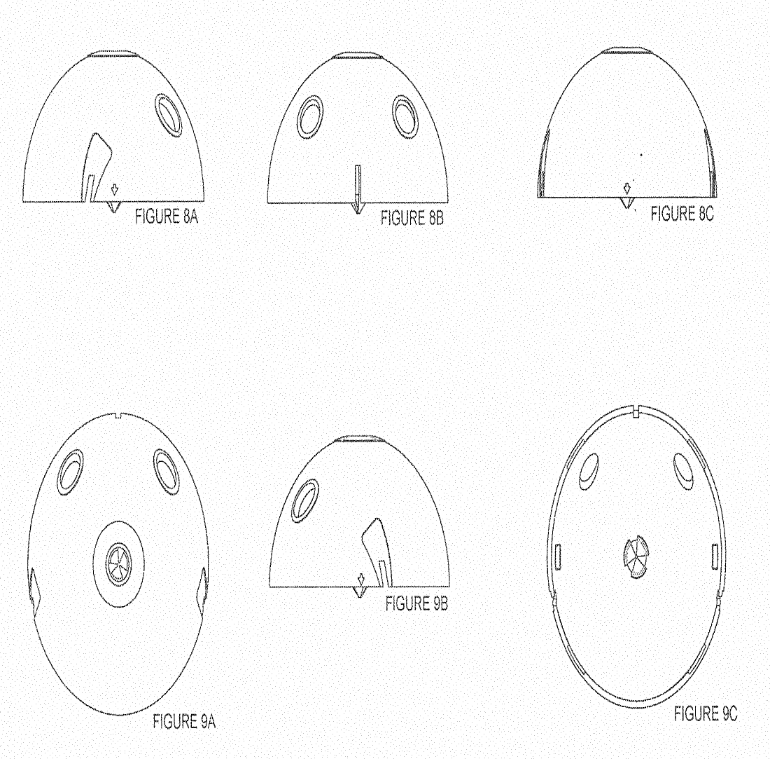

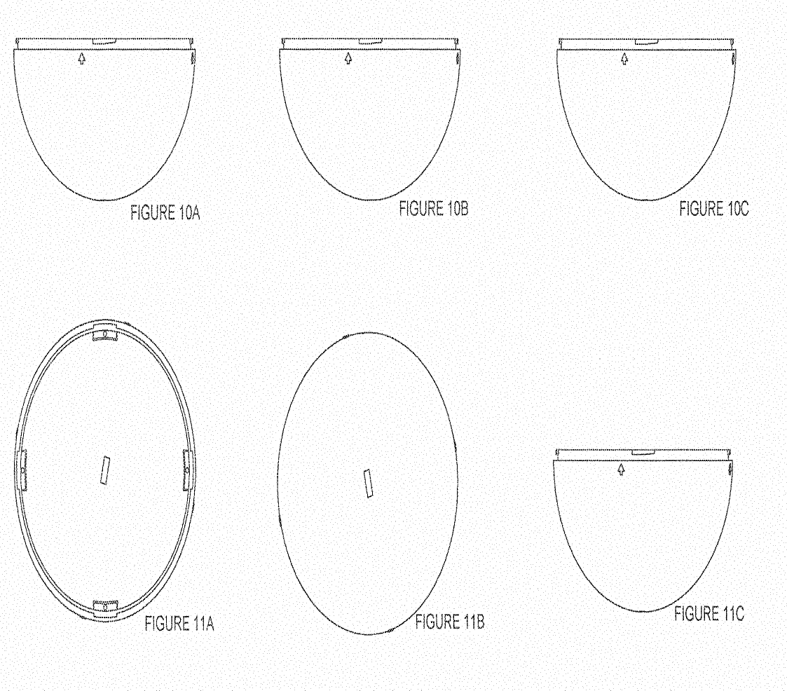

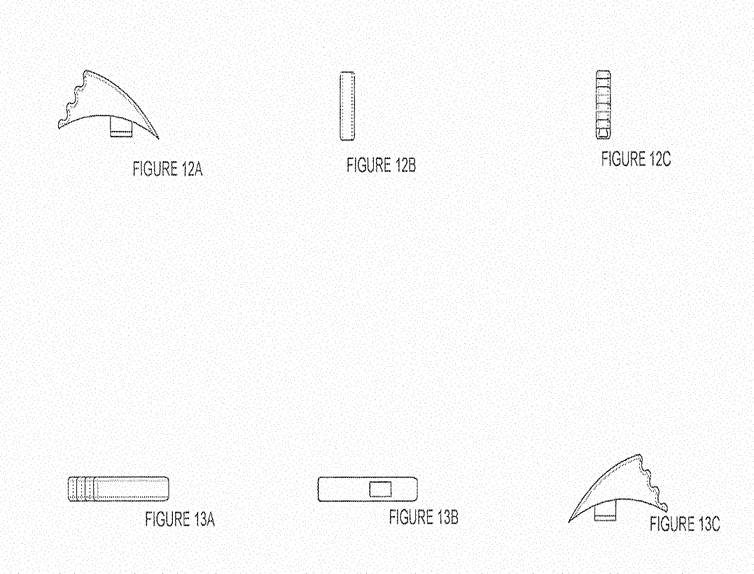

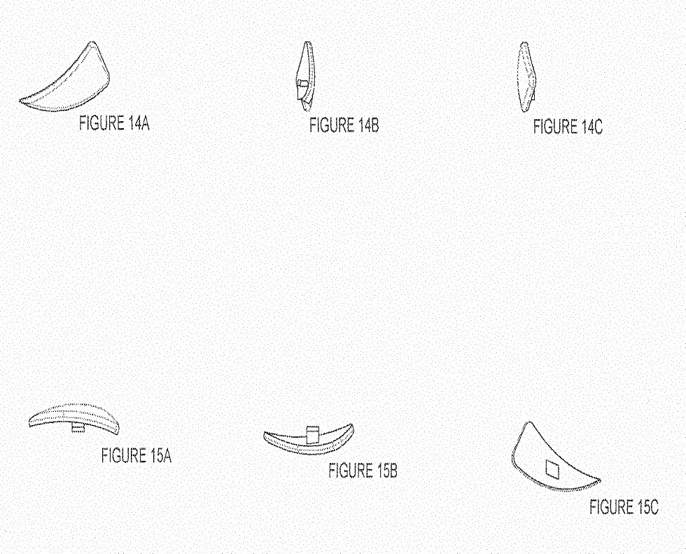

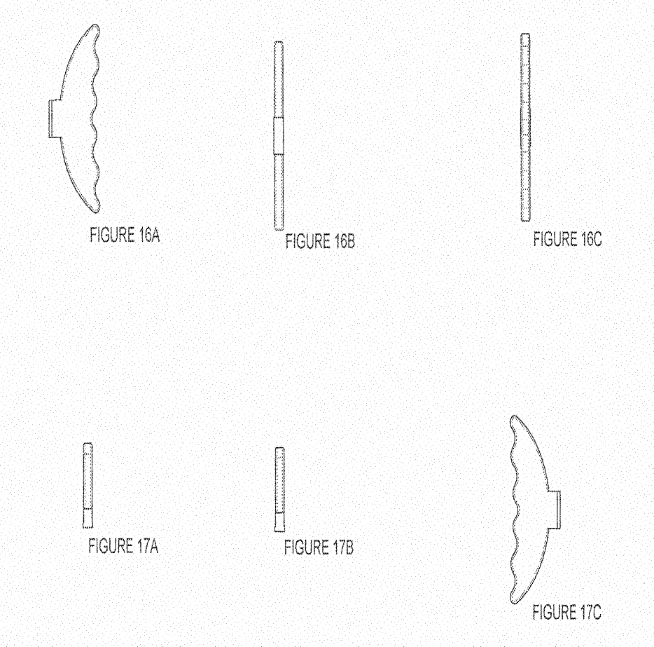

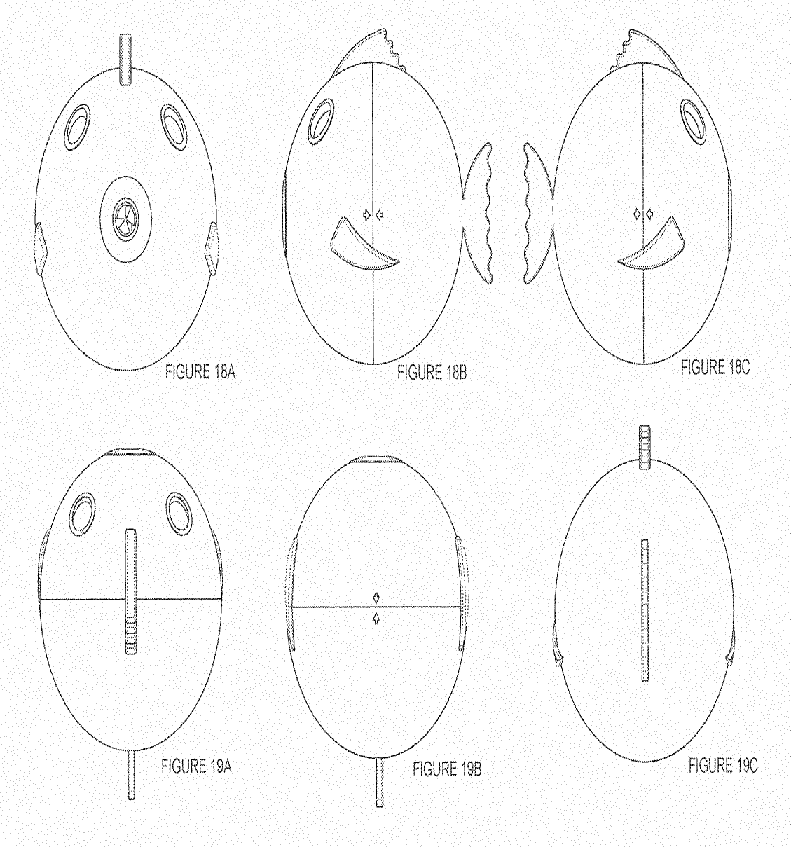

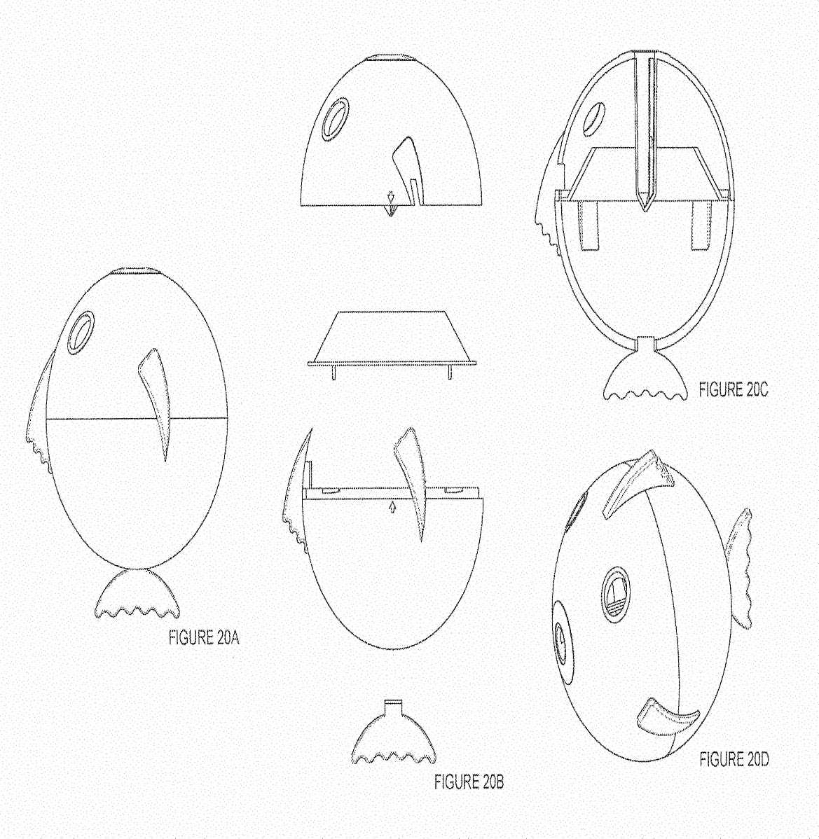

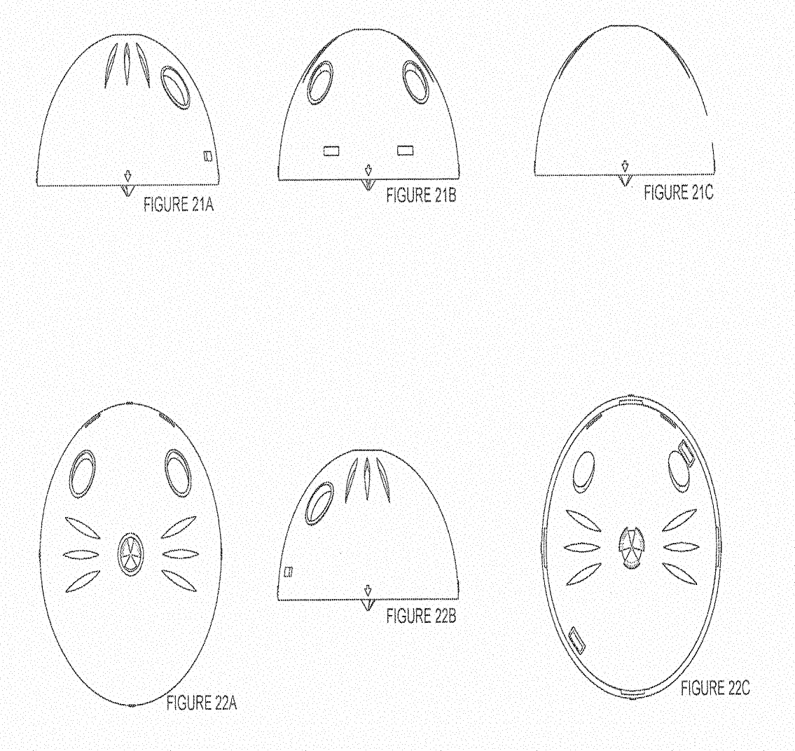

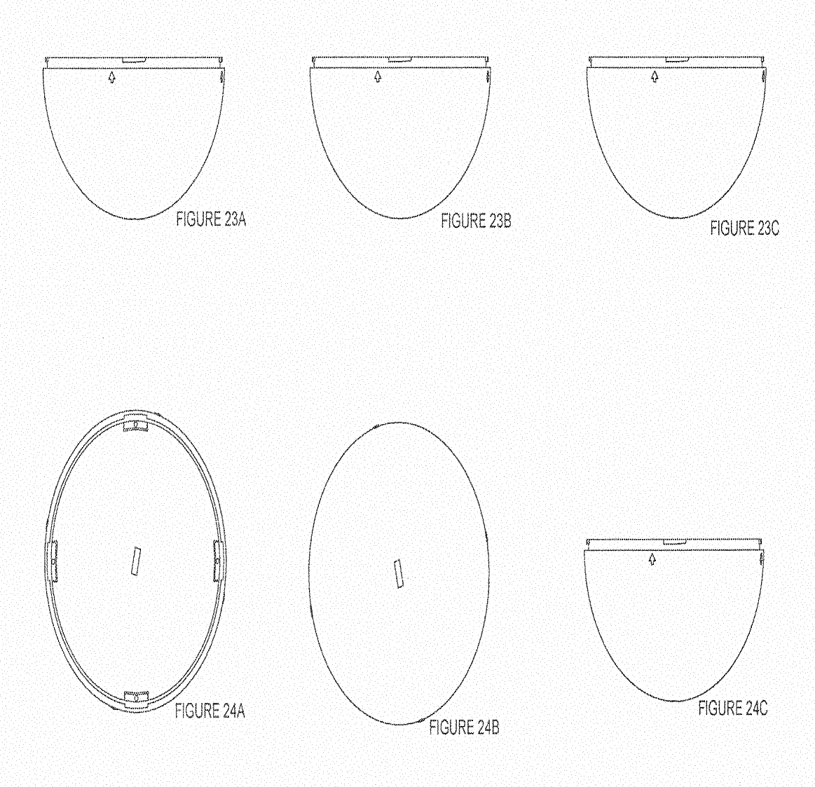

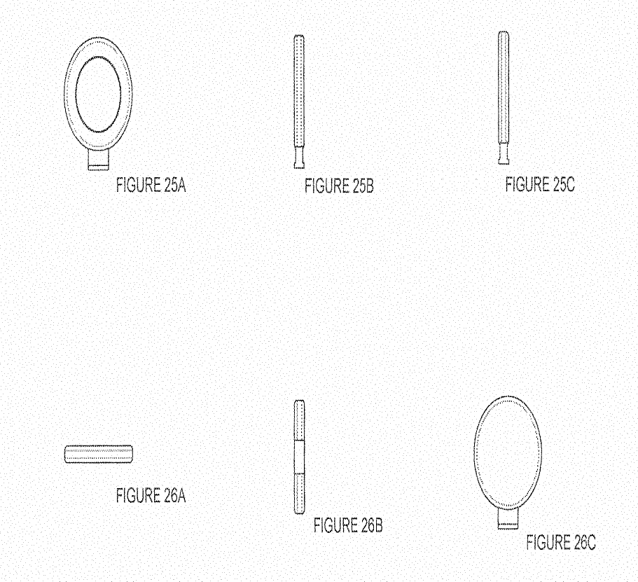

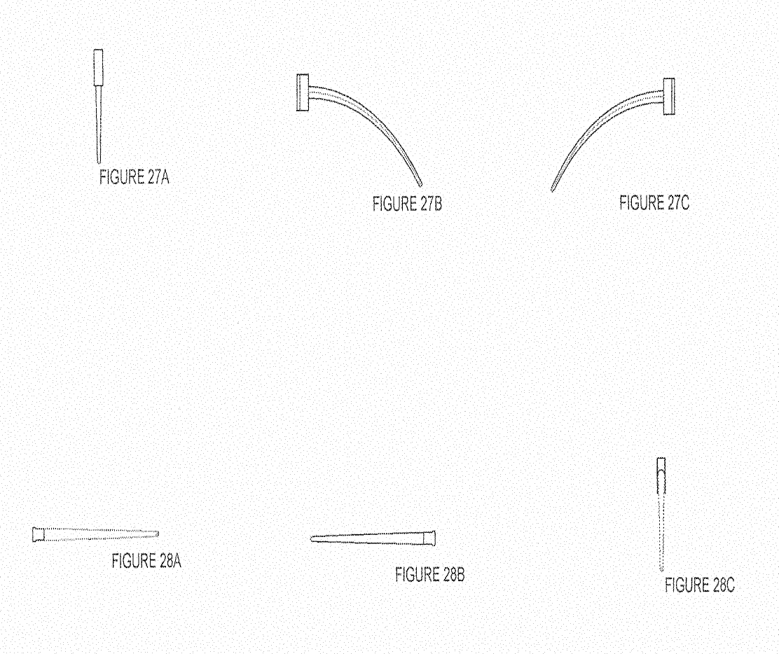

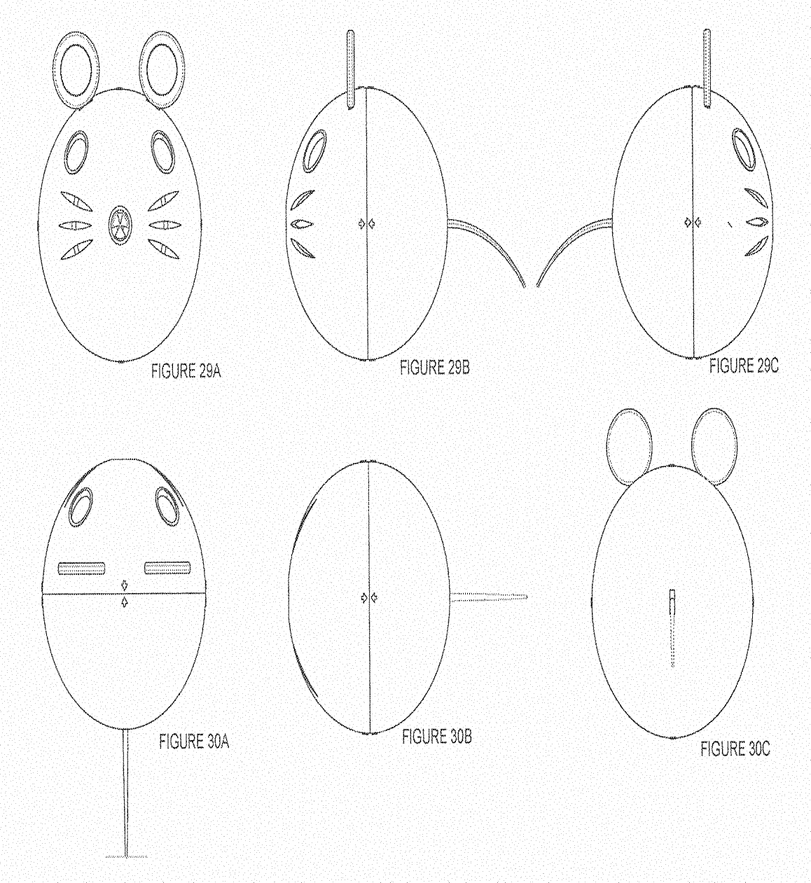

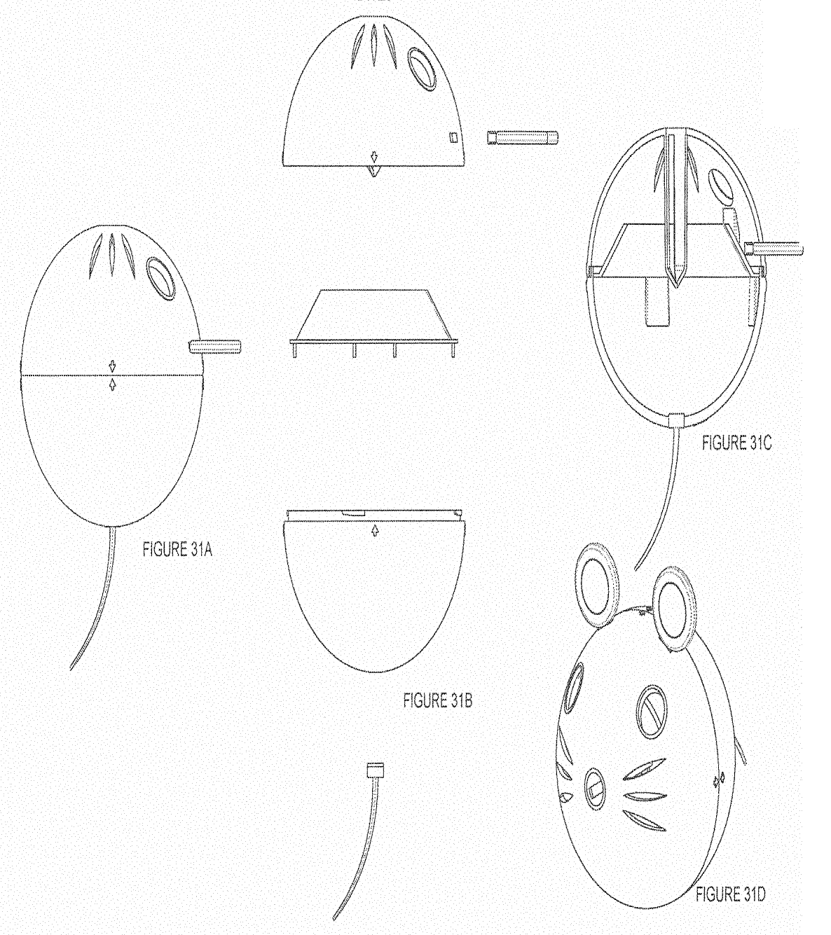

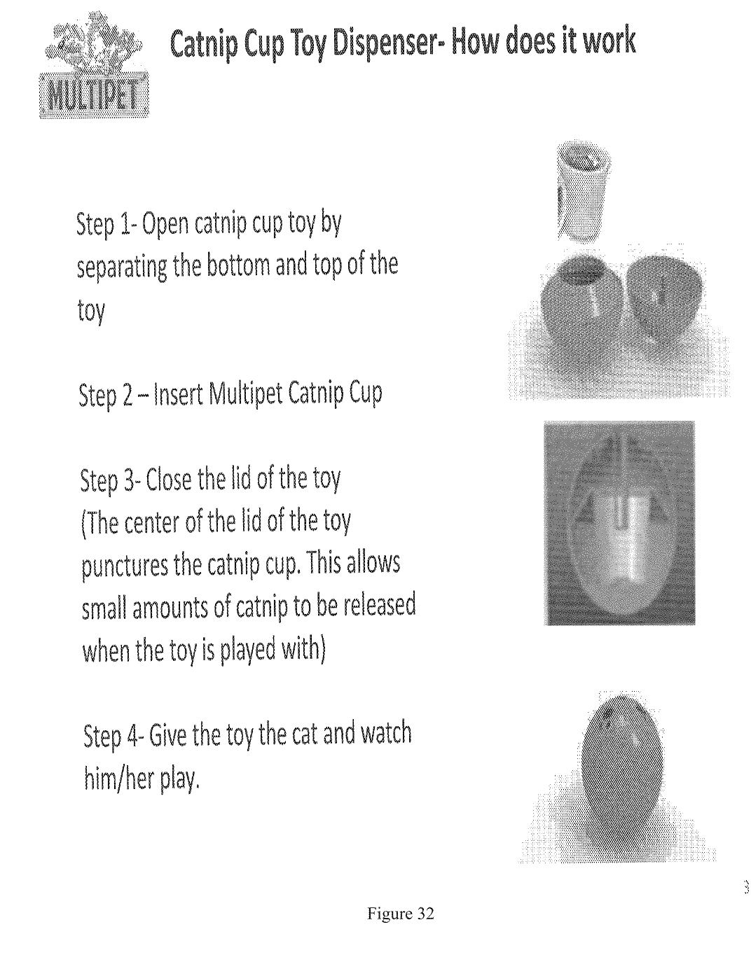

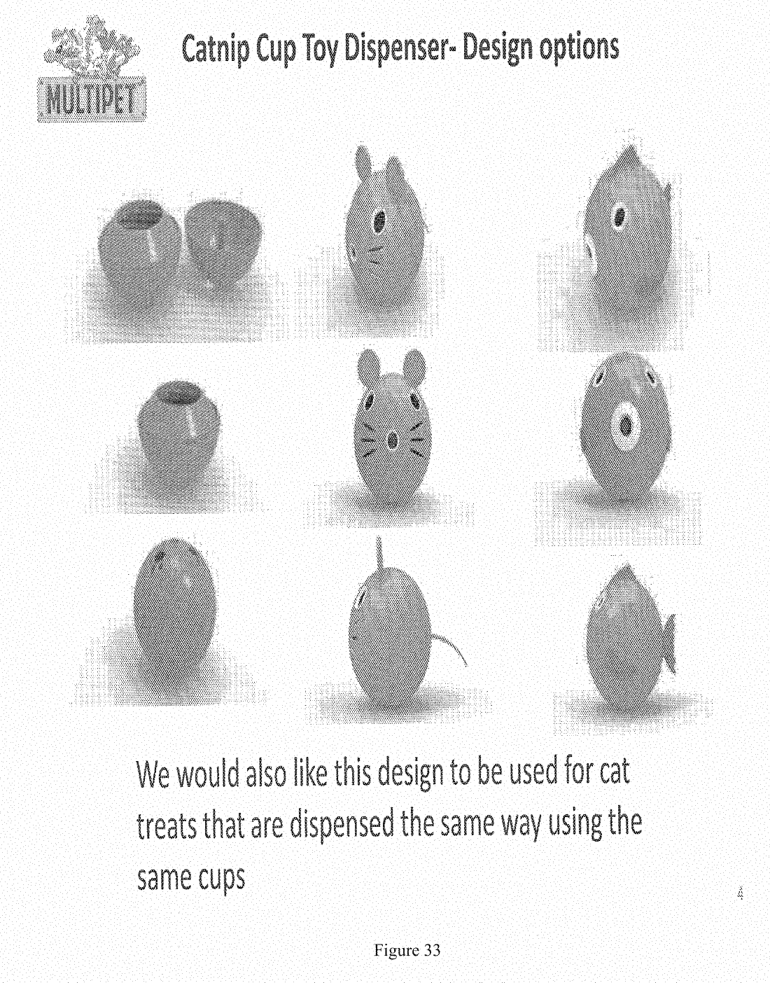

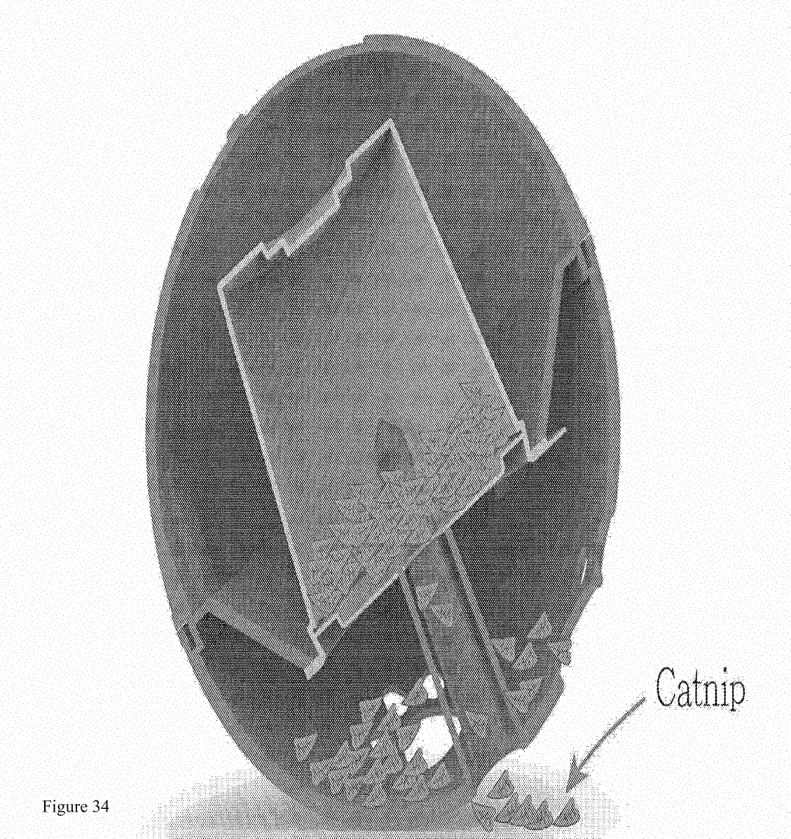

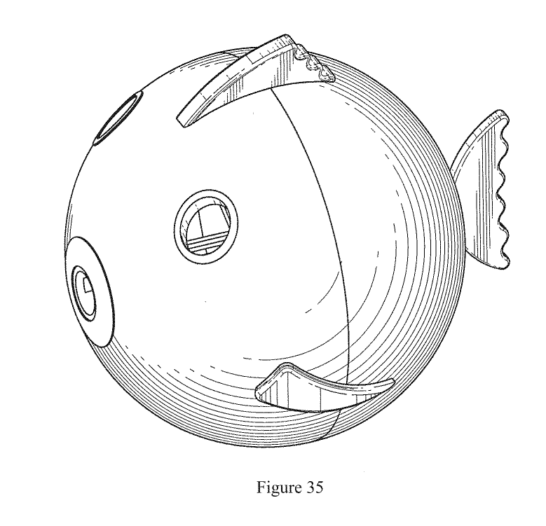

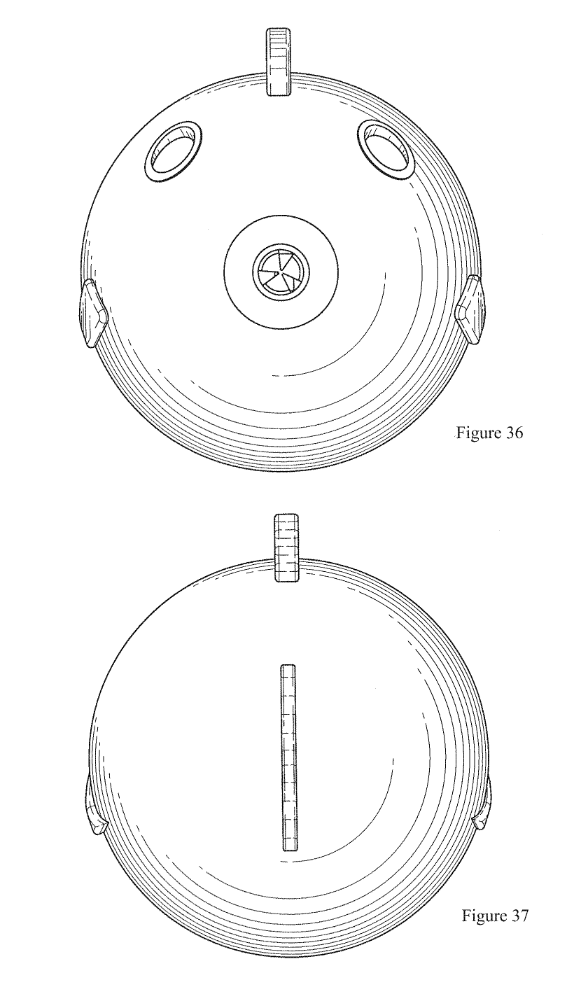

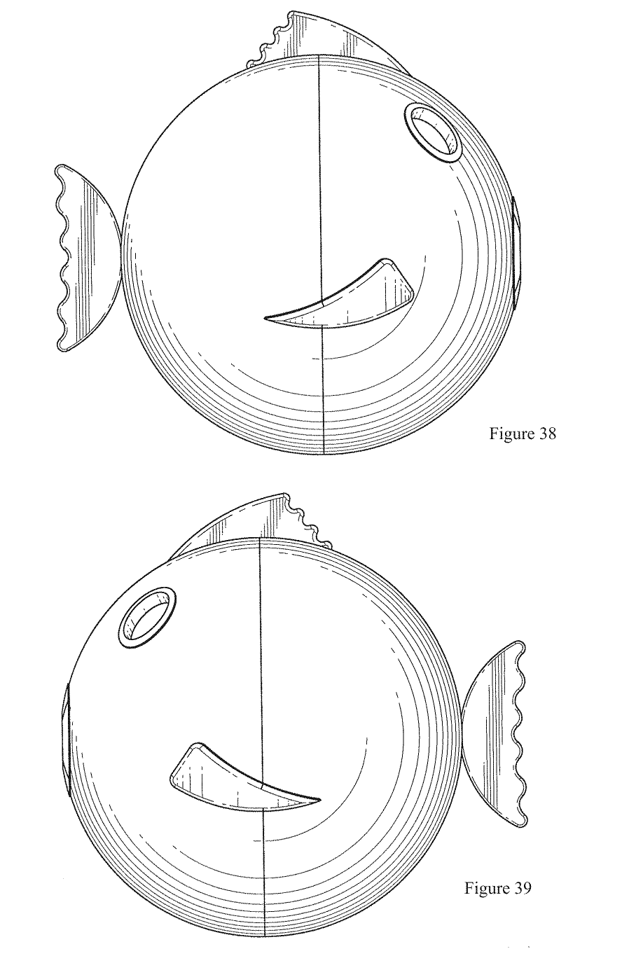

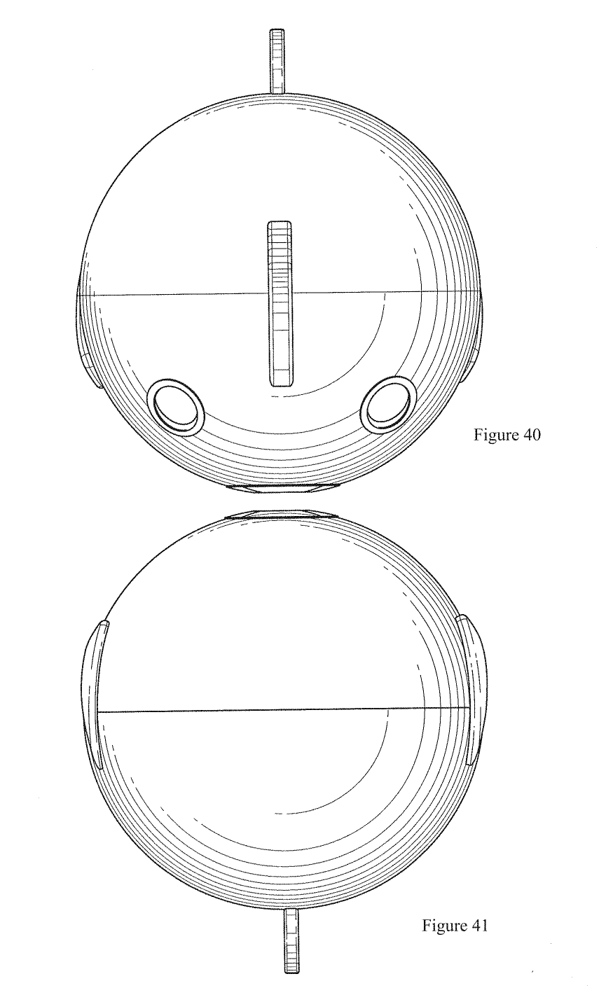

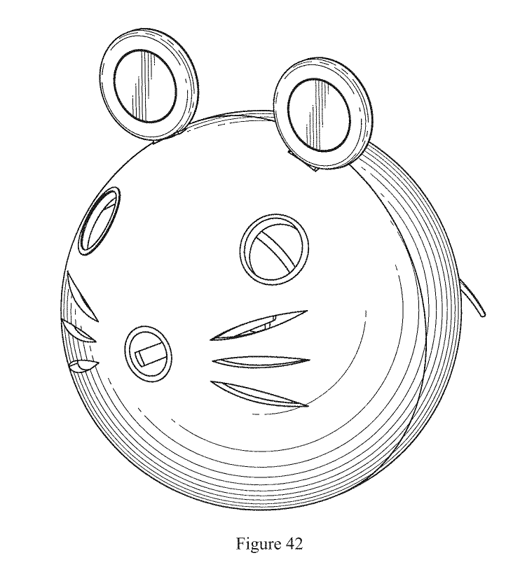

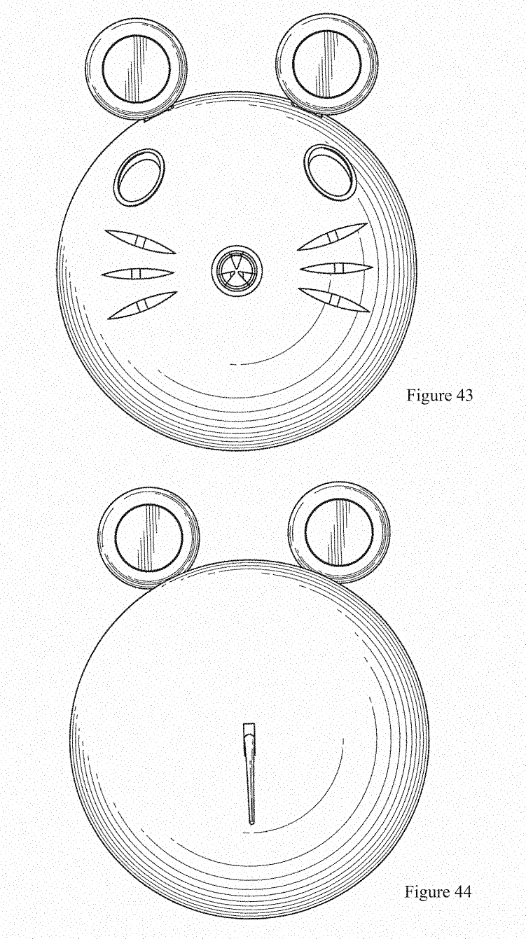

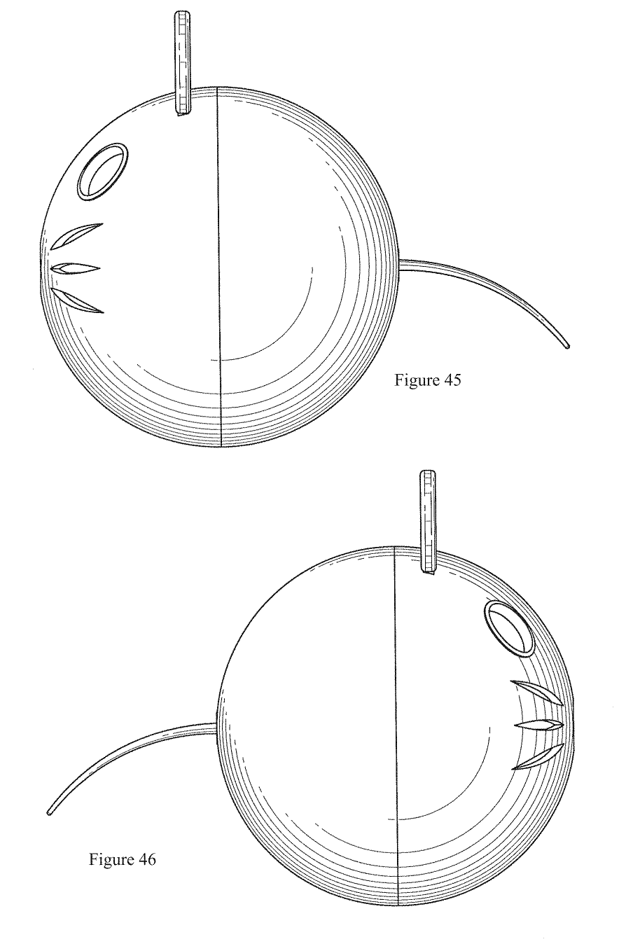

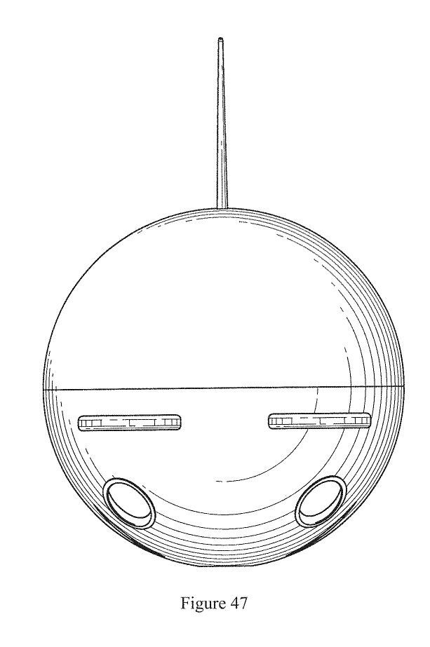

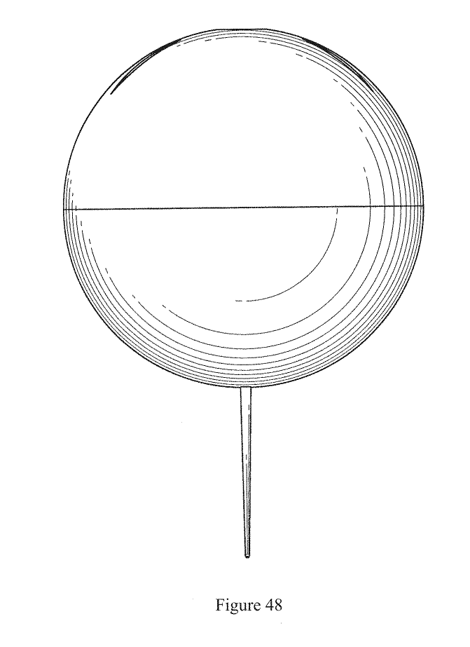

As shown in FIG. 34, catnip may be packaged in a container, such as a plastic cup sealed with a lid made of a material that may be punctured, such as aluminum foil. As shown in FIG. 32, in one aspect, the plastic cup may be placed within top and bottom hollow hemispherical portions as shown in FIGS. 1A-C and 2A-C respectively. One hemispherical portion shown in FIGS. 2C and 7C may include a puncture device to puncture the foil of the plastic cup when both hemispherical portions are brought together. There may be a ring to hold the cup in place, as shown in FIGS. 7B and 7C. One or both hemispherical portions may have apertures to allow the catnip to spill out of the device, as shown in FIGS. 1A-C and 2A-C. Puncture device may include a conduit to allow catnip to flow out an aperture at end of puncture device, as shown in FIG. 34. When assembled, the dispenser may be spherical or partially or substantially spherical to facilitate rolling and dispensing catnip via apertures.

In one aspect, the dispenser may accommodate external features that modify the manner in which the dispenser moves when touched. In one non-limiting example, such external features shown in FIGS. 25A-C; 26A-C; 27A-C; 28A-C may be attached as shown in FIGS. 29A-C and 30A-C to change the manner in which the dispenser rolls on the ground when touched by a cat or human.

In another aspect, catnip may be placed inside the hemispheres without being placed inside a cup or container and may be dispensed via apertures.

1. A dispenser for dispensing a material stored in a container, comprising:
a first hemisphere; and
a second hemisphere comprising a puncture arm and at least one aperture, wherein the first and second hemispheres are capable of being mechanically coupled together and when mechanically coupled accommodate the container, and when mechanically coupled the puncture arm punctures the container allowing at least a portion of the material in the container to exit the container and the dispenser via the aperture.
